(19) United States
(12) Patent Application Publication
(10) Pub. No.: US 2026/0326229 A1
(43) Pub. Date: Oct. 22, 2026

(54) APPARATUS AND METHOD FOR MAGNETIC-ASSISTED WELDING

(71) Applicant: CRRC QINGDAO SIFANG CO., LTD., Shandong (CN)

(72) Inventors: Xiaohui HAN, Shandong (CN); Ye XU, Shandong (CN); Gangqing LI, Shandong (CN); Jiehe YE, Shandong (CN); Yong LIU, Shandong (CN)

(21) Appl. No.: 19/159,969

(22) PCT Filed: Mar. 1, 2021
(86) PCT No.: PCT/CN2021/078408

§ 371 Date: Aug. 26, 2025

(30) Foreign Application Priority Data
Sep. 2, 2020 (CN) 202010911455.4

(51) Int. Cl. B23K 11/11; B23K 11/00; B23K 11/36

(52) U.S. Cl. CPC B23K 11/11; B23K 11/0006; B23K 11/36

(57) ABSTRACT

Provided is a magnetic assisted welding apparatus, comprising: a first electrode, a second electrode, a substrate, a first to-be-welded workpiece a second to-be-welded workpiece, and a magnetic unit; The first to-be-welded workpiece and the second to-be-welded workpiece are superposed and provided between the first electrode and the substrate, the second electrode and the second to-be-welded workpiece abut against the substrate, the magnetic unit surrounds outside the first electrode, the first electrode abuts against a surface of the first to-be-welded workpiece, and the first electrode forms a nugget between the first to-be-welded workpiece and the second to-be-welded workpiece, and the nugget is stirred by the magnetic unit.

### CROSS-REFERENCES TO RELATED APPLICATIONS

The present application claims priority to Chinese patent application No. 2020109114554, filed on Sep. 2, 2020, entitled “Magnetic Assisted Welding Apparatus and Welding Method”, which is hereby incorporated by reference in its entirety.

### FIELD

The present application relates to the field of welding, and in particular to an apparatus and method for magnetic-assisted welding.

### BACKGROUND

Welding is an important process in railway vehicle manufacturing, and resistance spot welding plays an important role in railway vehicle welding. Resistance spot welding is a key connection process for thin-walled structures such as a vehicle body due to advantages of high efficiency, low cost and being prone to automation. However, resistance spot welding joints are prone to joint softening and local overheating, resulting in excessively deep indentations and obvious residual burn traces, which seriously affect surface quality of welding spots. For parts with high appearance requirements (such as unpainted stainless steel subway side walls, etc.), a commonly used processing method is to use a single-sided resistance spot welding process, assisted by post-weld manual mechanical or chemical indentation removal treatment. However, the manual indentation removal treatment is time-consuming and labor-intensive and has very limited effects.

Studies have shown that the indentation can be reduced to a certain extent by decreasing current or increasing welding pressure, but this seriously affects the quality of the joint welding and causes major safety hazards. Therefore, it is necessary to adopt an efficient and reliable welding method to achieve single-sided resistance spot welding without indentation while ensuring the welding quality.

As a result, the present application is provided.

### BRIEF SUMMARY

The present application is intended to address at least one of the problems in the related art. The present application provides an apparatus for magnetic-assisted welding which solves defects in the related art that indentations generated during appearance welding of components affect the appearance quality of the components. By providing a magnetic unit around electrodes, a magnetic field for stirring nuggets is generated inside a to-be-welded workpiece during a welding process of the to-be-welded workpiece. The magnetic field interacts with welding current to regulate molten metal in a weld zone in three dimensions and in real time, increasing microhardness of microstructure inside the nugget, improving a morphology of the nugget, and greatly weakening a softening effect of a molten zone in an axial direction, thereby reducing the indentation.

The present application further provides a method for magnetic-assisted welding which solves defects in the related art that indentations generated during appearance welding of components affect the appearance quality of the components, reduces indentations on the surface of the to-be-welded workpiece and improves morphology of the nugget.

An apparatus for magnetic-assisted welding according to an embodiment of the present application includes: a first electrode, a second electrode, a substrate, a first to-be-welded workpiece, a second to-be-welded workpiece, and a magnetic unit;
wherein the first to-be-welded workpiece and the second to-be-welded workpiece are superposed and provided between the first electrode and the substrate;
the second electrode and the second to-be-welded workpiece abut against the substrate;
the magnetic unit surrounds outside the first electrode;
the first electrode abuts against a surface of the first to-be-welded workpiece, and the first electrode forms a nugget between the first to-be-welded workpiece and the second to-be-welded workpiece; and
the nugget is stirred by the magnetic unit.

According to an embodiment of the present application, a stirring magnetic field is formed between the first to-be-welded workpiece and the second to-be-welded workpiece through the magnetic unit, and the stirring magnetic field guides the nugget to form a divergent morphology from a center of the nugget.

In an embodiment, by providing a magnetic unit capable of forming a stirring magnetic field, the nugget is stirred to form the divergent morphology from the center of the nugget, solving the problem of too deep indentation during welding. The magnetic unit is configured to electromagnetically stir the weld zone, increasing the microhardness of a joint, improving a morphology of the nugget, preferably, improving the morphology of the nugget to a peanut shape and minimizing the single-sided point indentation to the greatest extent.

It should be noted that in this solution, in the welding process of single-sided resistance spot welding, the welding of the first to-be-welded workpiece and the second to-be-welded workpiece is realized through the single-sided resistance spot welding tooling composed of the first electrode and the magnetic unit.

It should also be noted that the substrate is made of copper, the first to-be-welded workpiece and the second to-be-welded workpiece are made of any or a combination of materials such as stainless steel, aluminum alloy, advanced high-strength steel, titanium alloy, etc. By sleeving the magnetic unit around the periphery of the first electrode in this solution, the appearance quality in the single-sided resistance spot welding process is significantly improved, and the single-sided point indentation is minimized to the greatest extent, which has application scope including, but not limited to, related fields such as rail transportation equipment, aerospace and automobile manufacturing.

Furthermore, through the effect of electromagnetic stirring, heat transfer of a temperature field and a flow velocity of flow field particles can be accelerated, and quality defects caused by insufficient heat in the center of the thick-walled material nugget, such as internal shrinkage, unfused zone, etc. can be effectively suppressed, optimizing and improving nugget formation quality.

Furthermore, the solution can effectively improve the heat distribution. By decreasing resistance heat acting on the first to-be-welded workpiece, a penetration rate of the nugget in a zone outside the substrate may be reduced from the traditional 50-60% to 30-40%, effectively improving the appearance effect while ensuring a qualified nugget diameter and the penetration rate.

According to one embodiment of the present application, a clamping unit surrounds outside the magnetic unit;
the clamping unit includes an outer clamping wall, an inner clamping wall and a connection rib;
where the outer clamping wall and the inner clamping wall sleeve with each other, and the connection rib connects the outer clamping wall and the inner clamping wall;
an inner surface of the outer clamping wall, an outer surface of the inner clamping wall and a side surface of the connection rib enclose to form an accommodation space for accommodating the electromagnetic unit;
an inner side of the inner clamping wall forms a first passage through which the first electrode passes;
where an end of the outer clamping wall at a side of the accommodation space is flush with the first electrode, or an end of the first electrode is located inside the accommodation space.

A relative position between the magnetic unit and the first electrode is ensured to be fixed by providing the clamping unit.

According to an embodiment of the present application, the connection rib is provided with at least one vent for introducing shielding gas into the accommodation space.

By introducing the shielding gas into the accommodation space for accommodating the magnetic unit, gas sealing is formed, avoiding a problem that the welding spots are oxidized during the welding process. By providing the vent in this solution, the post-weld welding spots have no oxidation color, without additional processes such as post-weld manual indentation removal treatment and without increasing additional energy consumption during the welding process, which has the characteristics of economy, convenience and efficiency.

According to an embodiment of the present application, an inner surface of the outer clamping wall at another side of the accommodation space is provided with a thread matched with the first electrode.

By providing the thread, a connection mode between the clamping unit and the first electrode is provided, and the clamping unit, the magnetic unit and the first electrode can be detachedly connected.

According to an embodiment of the present application, the clamping unit is an elastic and high-temperature resistant material.

In an embodiment, an elastic and high-temperature resistant clamping unit, such as high-temperature resistant rubber is nested on the rigid magnetic unit. The elastic deformation of the clamping unit is utilized to ensure that no damage is caused to an exposed surface, and a closed space can be simultaneously formed to ensure that the shielding gas effectively covers the weld zone, forming a good protection effect.

According to an embodiment of the present application, the magnetic unit is a cylindrical permanent magnet surrounding the first electrode, a side wall of the cylindrical permanent magnet is provided with an opening communicating a top surface with a bottom surface and the opening forms a second passage through which the shielding gas passes.

An implementation of the magnetic unit is provided, and the cylindrical permanent magnet is prone to be mounted and dismounted, which greatly improves the convenience of the welding process.

According to an embodiment of the present application, the magnetic unit includes several permanent magnets surrounding the first electrode and distributed in a circular array and a gap between two adjacent permanent magnets forms a second passage through which the shielding gas passes.

An implementation of the magnetic unit is provided, several permanent magnets distributed in the circular array make the magnetic field distributed more uniformly, and is easier and more sufficient to introduce shielding gas to the accommodation space. By symmetrically providing the permanent magnets in the circular array, morphology of the magnetic field formed by the magnetic unit is improved and the stirring of the stirring magnetic field to the inside of the nugget is optimized.

A method for magnetic-assisted welding according to an embodiment of the present application, performed using the above-mentioned apparatus for magnetic-assisted welding, includes the following steps:
sleeving the magnetic unit nested with a clamping unit outside the first electrode;
moving the first electrode to abut against a surface of the first to-be-welded workpiece;
introducing shielding gas into an accommodation space of the clamping unit; and
turning on a power supply to enter a weld stage for welding the first to-be-welded workpiece and the second to-be-welded workpiece.

According to an embodiment of the present application, after turning on the power supply to enter the weld stage for welding the first to-be-welded workpiece and the second to-be-welded workpiece, the method further includes:
continuously powering to enter a hold stage, and continuously introducing shielding gas into the accommodation space during the hold stage;
where a current intensity of the hold stage is less than or equal to 15% of the current intensity of the weld stage, and an abutment force between the first electrode and the surface of the first to-be-welded workpiece remains unchanged.

After the magnetic unit and the clamping unit sleeve outside the first electrode, a vent is provided on the clamping unit to ensure the gas sealing during the welding process and to prevent the welding spots from being oxidized.

Furthermore, the shielding gas is continuously introduced before the weld stage starts and after the hold stage ends, ensuring that the welding spots are always in the gas sealing environment formed by the shielding gas during the welding process, ensuring that the welding spots are not oxidized, and avoiding the need for post-weld electrolytic decolorization operation.

The above one or more solutions in the embodiments of the present application have at least one of the following technical effects. In the apparatus and method for magnetic-assisted welding provided by embodiments of the present application, by providing the magnetic unit around electrodes of the welding apparatus, a magnetic field for stirring nuggets is generated inside a to-be-welded workpiece during a welding process of the to-be-welded workpiece. The magnetic field interacts with welding current to regulate molten metal in a weld zone in three dimensions and in real time, increasing microhardness of microstructure inside the nugget, improving a morphology of the nugget, and greatly weakening a softening effect of a molten zone in an axial direction, thereby reducing the indentation.

Additional aspects and advantages of the present application will be set forth in part in the description which follows and, in part, will be apparent from the description, or may be learned by practice of the present application.

### BRIEF DESCRIPTION OF THE DRAWINGS

To more clearly illustrate technical solutions in the present application or the prior art, the drawings needed to be used in the descriptions of the embodiments or the prior art will be briefly introduced below. The drawings in the following description are some embodiments of the present application, and other drawings can be obtained according to the drawings for those skilled in the art without any creative work.

FIG. 1 is a schematic diagram showing an assembly relationship of a first electrode, a second electrode, a substrate, a first to-be-welded workpiece, a second to-be-welded workpiece, and a clamping unit in an apparatus for magnetic-assisted welding according to an embodiment of the present application;

FIG. 2 is a first schematic diagram showing an assembly relationship of a first electrode, a second electrode, a substrate, a first to-be-welded workpiece, a second to-be-welded workpiece, a clamping unit and a magnetic unit in an apparatus for magnetic-assisted welding according to an embodiment of the present application;

FIG. 3 is a second schematic diagram showing an assembly relationship of a first electrode, a second electrode, a substrate, a first to-be-welded workpiece, a second to-be-welded workpiece, a clamping unit and a magnetic unit in an apparatus for magnetic-assisted welding according to an embodiment of the present application;

FIG. 4 is a first schematic structural diagram of a clamping unit in an apparatus for magnetic-assisted welding according to an embodiment of the present application;

FIG. 5 is a second schematic structural diagram of a clamping unit in an apparatus for magnetic-assisted welding according to an embodiment of the present application;

FIG. 6 is a third schematic structural diagram of a clamping unit in an apparatus for magnetic-assisted welding according to an embodiment of the present application;

FIG. 7 is a first schematic diagram of a control logic flow of a method for magnetic-assisted welding according to an embodiment of the present application; and

FIG. 8 is a second schematic diagram of a control logic flow of a method for magnetic-assisted welding according to an embodiment of the present application.

Reference signs: 1: first electrode; 2: second electrode; 3: substrate; 4: first to-be-welded workpiece; 5: second to-be-welded workpiece; 6: magnetic unit; 7: clamping unit; 701: outer clamping wall; 702: inner clamping wall; 703: connection rib; 704: vent; 705: thread.

### DETAILED DESCRIPTION

To make the object, solutions and advantages of the embodiments of the present application more clear, the solutions in the embodiments of the present application are clearly and completely described in the following with reference to the accompanying drawings in the embodiments of the present application. These embodiments are a part of the embodiments of the present application, and not all of the embodiments. All other embodiments obtained by those skilled in the art based on the embodiments of the present application without any creative work belong to the scope of the present application.

In the description of the embodiments of the present application, it is to be noted that the orientation or positional relationships indicated by the terms such as “center,” “longitudinal,” “lateral,” “upper,” “lower,” “front,” “rear,” “left,” “right,” “vertical,” “horizontal,” “top,” “bottom,” “inside,” and “outside,” are based on the orientation or positional relationship shown in the drawings, and are merely for the convenience of describing the embodiments of the present application and simplifying the description, rather than indicating or implying that the device or component stated must have a particular orientation, or be constructed and operated in a particular orientation, and thus is not to be construed as limitation to the embodiments of the present application. Furthermore, the terms “first”, “second”, “third” are only used for descriptive purposes and should not be construed as indicating or implying a relative importance.

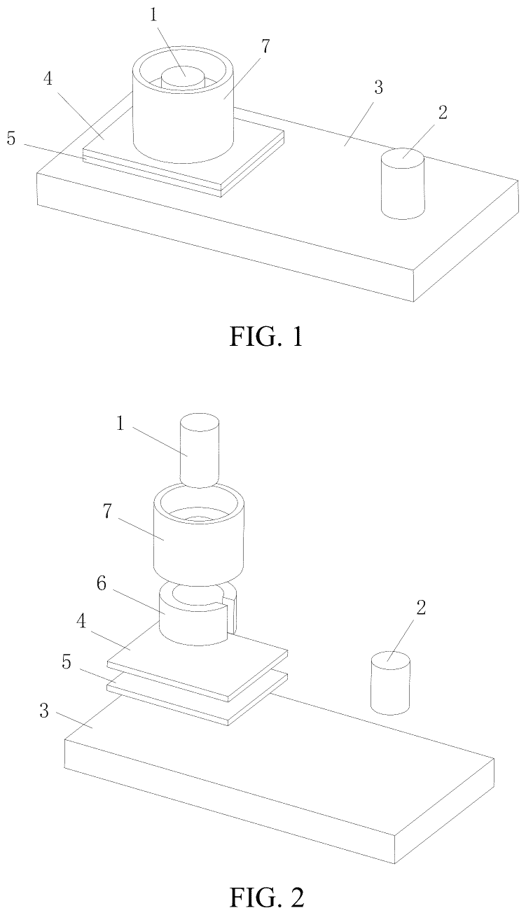

FIG. 1 is a schematic diagram showing an assembly relationship of a first electrode 1, a second electrode 2, a substrate 3, a first to-be-welded workpiece 4, a second to-be-welded workpiece 5, and a clamping unit 7 in an apparatus for magnetic-assisted welding according to an embodiment of the present application. It can be seen from FIG. 1, a setting relationship between the various components of the present application, it should be noted that a magnetic unit 6 is clamped inside the clamping unit 7. FIG. 1 shows a solution with a clamping unit 7. In practical applications, the clamping unit 7 may also be omitted, and the connection between the magnetic unit 6 and the first electrode 1 can be achieved by bonding or other methods.

Further, by providing a surrounding magnetic unit 6 at a periphery of the first electrode land a magnetization direction of the magnetic unit 6 is radial magnetization, a radial external magnetic field is generated in a nugget and its surrounding zone through the mutual repulsion of a magnetic units 6 in symmetrical positions. The radial external magnetic field is coupled and interacted with the welding current to regulate mass transfer and heat transfer behaviors of the molten metal in the weld zone in three dimensions and in real time.

In an embodiment, in this solution, in the welding process of single-sided resistance spot welding, the welding of the first to-be-welded workpiece 4 and the second to-be-welded workpiece 5 is realized through the single-sided resistance spot welding tooling composed of the first electrode 1 and the magnetic unit 6.

Furthermore, resistance spot welding, in combination with the welding metallurgical characteristics of temperature field heat transfer and flow field particle flow in the nucleation process of resistance spot welding, may increase the microhardness of the weld core from a mechanism perspective, greatly weakening a softening effect of the molten zone in the axial direction, and reducing the indentation.

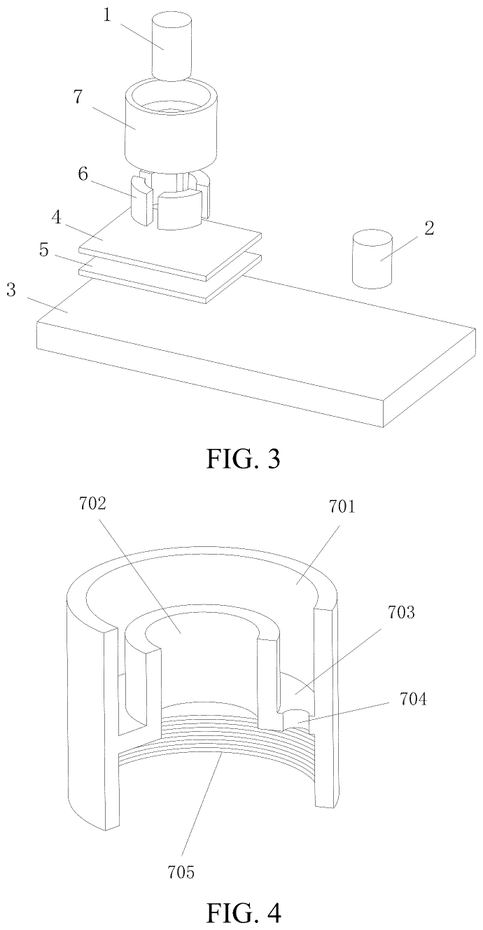

FIG. 2 and FIG. 3 are a first and second schematic diagram showing an assembly relationship of a first electrode 1, a second electrode 2, a substrate 3, a first to-be-welded workpiece 4, a second to-be-welded workpiece 5, a clamping unit 7 and a magnetic unit 6 in an apparatus for magnetic-assisted welding according to an embodiment of the present application, respectively. As can be seen from FIG. 2 and FIG. 3, the present application provides two implementations of the magnetic unit 6, and the clamping unit 7 corresponding to the magnetic unit 6 further has corresponding structural changes to fix the magnetic unit 6. However, it should be noted that the overall idea of fixing the magnetic unit 6 through the clamping unit 7 remains unchanged, that is, the magnetic unit 6 is clamped through an elastic wear-resistant material and connected to the first electrode 1. In an embodiment, the connection between the clamping unit 7 and the first electrode 1 can be achieved through the thread 705, or through the compression deformation of the inner clamping wall 702. In FIG. 2 and FIG. 3, only a schematic diagram of the end of the first electrode 1 is shown. In case that an end of the clamping unit 7 is provided with the thread 705, the first electrode 1 is also provided with a corresponding external thread connection structure.

Furthermore, in the present application, grains of the nugget microstructure are denser under electromagnetic stirring effect, increasing the microhardness of the nugget and greatly weakening the joint softening of a melted zone in a thickness direction of the nugget to achieve the engineering purpose of reducing the indentation.

Further, the macroscopic morphology of the traditional welding is optimized from an ellipse to a peanut shape, and the indentation of welding, especially the indentation of the single-sided point, is minimized to the greatest extent, and the indentation is reduced to a depth that is difficult to distinguish with naked eyes while ensuring that effective nugget diameters meet the standard requirements.

Furthermore, in the present application, through the electromagnetic stirring effect and coupled enhancement effect of the magnetic field and electric field, the three-dimensional energy distribution of the nugget is optimized, the energy weak zone in the center of the nugget is strengthened, the heat transfer of a temperature field and a flow velocity of flow field particles are accelerated, quality defects caused by insufficient heat in the center of the thick-walled material nugget, such as internal shrinkage, unfused zone, etc. are effectively suppressed, and nugget formation quality is optimized and improved.

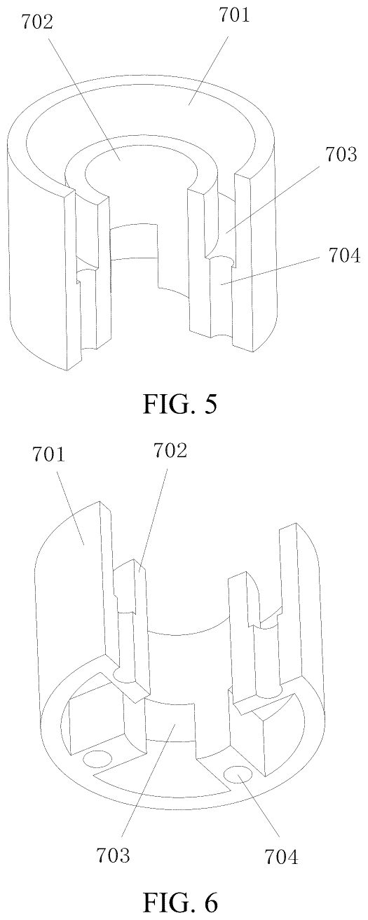

FIG. 4, FIG. 5 and FIG. 6 are first, second and third schematic structural diagrams of a clamping unit 7 in an apparatus for magnetic-assisted welding according to an embodiment of the present application. As can be seen from FIG. 4 to FIG. 6, the present application provides two structural schematic diagrams of clamping units 7 matched with the magnetic unit 6. In addition to the accommodation space for accommodating the magnetic unit 6, the clamping unit 7 is further provided with structures such as threads 705 and vents 704. In addition, the magnetic unit 6 is clamped through the outer clamping wall 701 and the inner clamping wall 702, and the connection with the first electrode 1 is achieved through the thread 705 or the inner clamping wall 702.

It should be noted that FIG. 6 shows an internal structure of a clamping unit 7. It can be seen from FIG. 6 that vertical ribs provided with vents 704 are flush with the end of the outer clamping wall 701. In practical applications, this part may also be provided to have a certain distance, and the distance of this part may be provided to the thread 705 as needed, which is convenient for being connected with the first electrode.

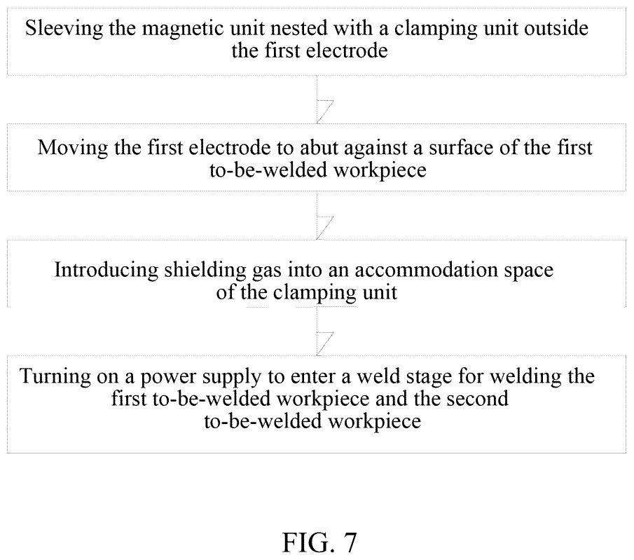

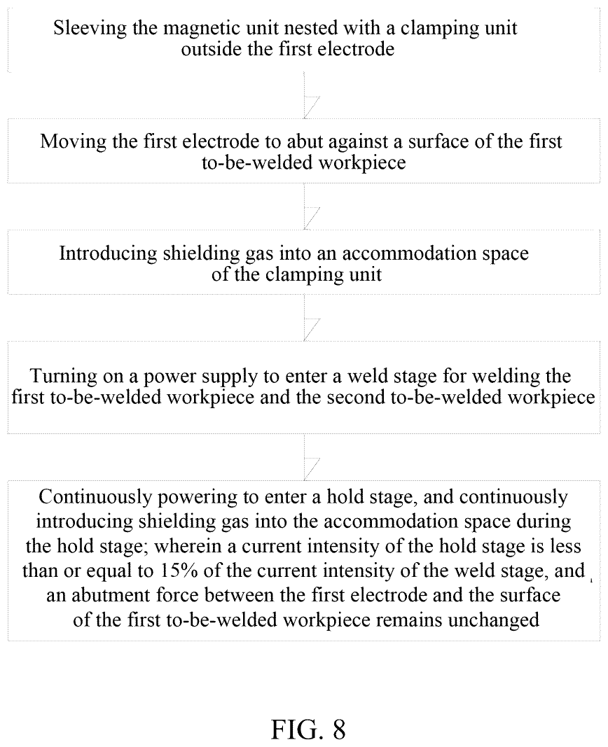

FIG. 7 and FIG. 8 are first and second schematic diagrams of a control logic of a method for magnetic-assisted welding according to an embodiment of the present application. Two schematic diagrams of a control logic of a method for magnetic-assisted welding are provided.

In the description of embodiments of the present application, it should be noted that, unless otherwise explicitly specified and defined, the terms “connected to” and “connected” shall be understood broadly. For example, it may be either fixedly connected or detachably connected, or may be integrally connected; it may be either mechanically connected, or electrically connected; it may be either directly connected, or indirectly connected through an intermediate medium. The specific meanings of the terms above in embodiments of the present application may be understood by those skilled in the art in accordance with specific conditions.

In the embodiments of the present application, unless otherwise clearly stated and defined, the first feature being located “on” or “under” the second feature means that the first feature is in direct contact with the second feature or the first feature is in contact with the second feature by an intermediate medium. In addition, the first feature is “on,” “above” and “over” the second feature can refer to that the first feature is directly above or obliquely above the second feature, or simply refer to that the level of the first feature is higher than that of the second feature. The first feature is “under”, “below” and “beneath” the second feature can refer to that the first feature is directly below or obliquely below the second feature, or simply refer to that the level of the first feature is lower than that of the second feature.

In some specific embodiments of the present application, as shown in FIG. 1 to FIG. 6, the present solution provides an apparatus for magnetic-assisted welding, including: a first electrode 1, a second electrode 2, a substrate 3, a first to-be-welded workpiece 4, a second to-be-welded workpiece 5, and a magnetic unit 6. The first to-be-welded workpiece 4 and the second to-be-welded workpiece 5 are superposed and provided between the first electrode 1 and the substrate 3; the second electrode 2 and the second to-be-welded workpiece 5 abut against the substrate 3; the magnetic unit 6 surrounds outside the first electrode 1; where the first electrode 1 abuts against the surface of the first to-be-welded workpiece 4, a nugget is formed between the first to-be-welded workpiece 4 and the second to-be-welded workpiece 5; and the nugget is stirred by the magnetic unit 6.

The present application provides an apparatus for magnetic-assisted welding to solves defects in the related art that indentations generated during appearance welding of components affect the appearance quality of the components. By providing the magnetic unit 6 around electrodes, a magnetic field for stirring nuggets is generated inside a to-be-welded workpiece during a welding process of the to-be-welded workpiece. The magnetic field interacts with welding current to regulate molten metal in a weld zone in three dimensions and in real time, increasing microhardness of microstructure inside the nugget, improving a morphology of the nugget, and greatly weakening a softening effect of a molten zone in an axial direction, thereby reducing the indentation.

In an embodiment, a stirring magnetic field is formed between the first to-be-welded workpiece 4 and the second to-be-welded workpiece 5 through the magnetic unit 6, and the stirring magnetic field guides the nugget to form a divergent morphology from a center of the nugget.

In an embodiment, by providing a magnetic unit 6 capable of forming a stirring magnetic field, the nugget is stirred to form the divergent morphology from the center of the nugget, solving the problem of too deep indentation during welding. The magnetic unit 6 is configured to electromagnetically stir the weld zone, increasing the microhardness of a joint, improving a morphology of the nugget, preferably, improving the morphology of the nugget a peanut shape and minimizing the single-sided point indentation to the greatest extent.

It should be noted that in this solution, in the welding process of single-sided resistance spot welding, the welding of the first to-be-welded workpiece 4 and the second to-be-welded workpiece 5 is realized through the single-sided resistance spot welding tooling composed of the first electrode 1 and the magnetic unit 6.

It should also be noted that the substrate 3 is made of copper, the first to-be-welded workpiece 4 and the second to-be-welded workpiece 5 are made of any or a combination of materials such as stainless steel, aluminum alloy, advanced high-strength steel, titanium alloy, etc. By sleeving the magnetic unit 6 around the periphery of the first electrode 1 in this solution, the appearance quality in the single-sided resistance spot welding process is significantly improved, and the single-sided point indentation is minimized to the greatest extent, which has application scope including, but not limited to, related fields such as rail transportation equipment, aerospace and automobile manufacturing.

Furthermore, through the effect of electromagnetic stirring, heat transfer of a temperature field and a flow velocity of flow field particles can be accelerated, and quality defects caused by insufficient heat in the center of the thick-walled material nugget, such as internal shrinkage, unfused zone, etc. can be effectively suppressed, optimizing and improving nugget formation quality.

Furthermore, the solution can effectively improve the heat distribution. By decreasing resistance heat acting on the first to-be-welded workpiece 4, a penetration rate of the nugget in a zone outside the substrate may be reduced from the traditional 50-60% to 30-40%, effectively improving the appearance effect while ensuring a qualified nugget diameter and the penetration rate.

In some embodiments, a clamping unit 7 surrounds outside the magnetic unit 6. The clamping unit 7 includes an outer clamping wall 701, an inner clamping wall 702 and a connection rib 703; where the outer clamping wall 701 and the inner clamping wall 702 sleeve with each other, and the connection rib 703 connects the outer clamping wall 701 and the inner clamping wall 702. An inner surface of the outer clamping wall 701, an outer surface of the inner clamping wall 702 and a side surface of the connection rib 703 enclose to form an accommodation space for accommodating the electromagnetic unit. An inner side of the inner clamping wall 702 forms a first passage through which the first electrode 1 passes; where an end of the outer clamping wall 701 at a side of the accommodation space is flush with the first electrode 1, or an end of the first electrode 1 is located inside the accommodation space.

A relative position between the magnetic unit 6 and the first electrode 1 is ensured to be fixed by providing the clamping unit 7.

It should be noted that this embodiment provides two implementations of the first electrode 1 inside the accommodation space. The two implementations of the first electrode 1 are adjusted based on the abutment force required by the substrate 3 in actual applications, and the sealing of the accommodation space where the magnetic unit 6 is located is achieved by squeezing the clamping unit 7.

According to an embodiment of the present application, the connection rib 703 is provided with at least one vent 704 for introducing shielding gas into the accommodation space.

By introducing the shielding gas into the accommodation space for accommodating the magnetic unit 6, gas sealing is formed, avoiding a problem that the welding spots are oxidized during the welding process. By providing the vent 704 in this solution, the post-weld welding spots have no oxidation color, without additional processes such as post-weld manual indentation removal treatment and without increasing additional energy consumption during the welding process, which has the characteristics of economy, convenience and efficiency.

In some embodiments, an inner surface of the outer clamping wall 701 at another side of the accommodation space is provided with a thread 705 matched with the first electrode 1.

By providing the thread 705, a connection mode between the clamping unit 7 and the first electrode 1 is provided, and the clamping unit 7, the magnetic unit 6 and the first electrode 1 can be detachedly connected.

In some embodiments, the clamping unit 7 is made of an elastic and high-temperature resistant material.

In an embodiment, an elastic and high-temperature resistant clamping unit 7, such as high-temperature resistant rubber is nested on the rigid magnetic unit 6. The elastic deformation of the clamping unit 7 is utilized to ensure that no damage is caused to an exposed surface, and a closed space can be simultaneously formed to ensure that the shielding gas effectively covers the weld zone, forming a good protection effect.

In some embodiments, the magnetic unit 6 is a cylindrical permanent magnet surrounding the first electrode 1, a side wall of the cylindrical permanent magnet is provided with an opening communicating a top surface with a bottom surface and the opening forms a second passage through which the shielding gas passes.

An implementation of the magnetic unit 6 is provided, and the cylindrical permanent magnet is prone to be mounted and dismounted, which greatly improves the convenience of the welding process.

In some embodiments, the magnetic unit 6 includes several permanent magnets surrounding the first electrode 1 and distributed in a circular array and a gap between two adjacent permanent magnets forms a second passage through which the shielding gas passes.

An implementation of the magnetic unit 6 is provided, several permanent magnets distributed in the circular array make the magnetic field distributed more uniformly, and is easier and more sufficient to introduce shielding gas to the accommodation space. By symmetrically providing the permanent magnets in the circular array, morphology of the magnetic field formed by the magnetic unit 6 is improved and the stirring of the stirring magnetic field to the inside of the nugget is optimized.

In some specific embodiments of the present application, as shown in FIG. 7 and FIG. 8, the present scheme provides a method for magnetic-assisted welding, performed using the above-mentioned apparatus for magnetic-assisted welding, includes the following steps:
sleeving the magnetic unit 6 nested with a clamping unit 7 outside the first electrode 1;
moving the first electrode 1 to abut against a surface of the first to-be-welded workpiece 4;
introducing shielding gas into an accommodation space of the clamping unit 7; and
turning on a power supply to enter a weld stage for welding the first to-be-welded workpiece 4 and the second to-be-welded workpiece 5.

The method for magnetic-assisted welding provided by the present application solves defects in the related art that indentations generated during appearance welding of components affect the appearance quality of the components, reduces indentations on the surface of the to-be-welded workpiece and improves morphology of the nugget.

In some embodiments, after turning on the power supply to enter the weld stage for welding the first to-be-welded workpiece 4 and the second to-be-welded workpiece 5, the method further includes:
continuously powering to enter a hold stage, and continuously introducing shielding gas into the accommodation space during the hold stage;
where a current intensity of the hold stage is less than or equal to 15% of the current intensity of the weld stage, and an abutment force between the first electrode 1 and the surface of the first to-be-welded workpiece 4 remains unchanged.

After the magnetic unit 6 and the clamping unit 7 sleeve outside the first electrode 1, a vent 704 is provided on the clamping unit 7 to ensure the gas sealing during the welding process and prevent the welding spots from being oxidized.

Furthermore, the shielding gas is continuously introduced before the weld stage starts and after the hold stage ends, ensuring that the welding spots are always in the gas sealing environment formed by the shielding gas during the welding process, ensuring that the welding spots are not oxidized, and avoiding the need for post-weld electrolytic decolorization operation.

In the description of the present specification, description with reference to the terms “one embodiment,” “some embodiments,” “an example,” “specific example,” “some examples” and the like, refers to that specific features, structures, materials or characteristics described in combination with an embodiment or an example are included in at least one embodiment or example of the embodiments of the present application. In this specification, the schematic expressions of the above terms do not necessarily refer to the same embodiment or example. Furthermore, the particular features, structures, materials or characteristics described may be combined in any suitable manner in any one or more embodiments or examples. In addition, those skilled in the art may combine different embodiments or examples described in this specification, as well as the features of different embodiments or examples, without conflicting each other.

Finally, it should be noted that the above embodiments are only used to illustrate the present application, but not to limit the present application. Although the application has been described in detail with reference to the embodiments, those skilled in the art should understand that various combinations, modifications, or equivalent replacements of the technical solutions of the application do not depart from the spirit and scope of the solutions of the application, and should all cover the scope of the claims of the present application.

1. An apparatus for magnetic assisted welding, comprising: a first electrode, a second electrode, a substrate, a first to-be-welded workpiece, a second to-be-welded workpiece, and a magnetic unit;
wherein the first to-be-welded workpiece and the second to-be-welded workpiece are superposed and provided between the first electrode and the substrate;
the second electrode and the second to-be-welded workpiece abut against the substrate;
the magnetic unit surrounds outside the first electrode;
the first electrode abuts against a surface of the first to-be-welded workpiece, and the first electrode forms a nugget between the first to-be-welded workpiece and the second to-be-welded workpiece; and
the nugget is stirred by the magnetic unit.

2. The apparatus of claim 1, wherein a stirring magnetic field is formed between the first to-be-welded workpiece and the second to-be-welded workpiece through the magnetic unit, and the stirring magnetic field guides the nugget to form a divergent morphology from a center of the nugget.

3. The apparatus of claim 1, wherein a clamping unit surrounds outside the magnetic unit;
the clamping unit comprises an outer clamping wall, an inner clamping wall and a connection rib;
wherein the outer clamping wall and the inner clamping wall sleeve with each other, and the connection rib connects the outer clamping wall and the inner clamping wall;
an inner surface of the outer clamping wall, an outer surface of the inner clamping wall and a side surface of the connection rib enclose to form an accommodation space for accommodating the electromagnetic unit;
an inner side of the inner clamping wall forms a first passage through which the first electrode passes;
wherein an end of the outer clamping wall at a side of the accommodation space is flush with the first electrode, or an end of the first electrode is located inside the accommodation space.

4. The apparatus of claim 3, wherein the connection rib is provided with at least one vent for introducing shielding gas into the accommodation space.

5. The apparatus of claim 4, wherein an inner surface of the outer clamping wall at another side of the accommodation space is provided with a thread matched with the first electrode.

6. The apparatus of claim 4, wherein the clamping unit is made of an elastic high-temperature resistant material.

7. The apparatus of claim 4, wherein the magnetic unit is a cylindrical permanent magnet surrounding the first electrode, a side wall of the cylindrical permanent magnet is provided with an opening communicating a top surface with a bottom surface and the opening forms a second passage through which the shielding gas passes.

8. The apparatus of claim 4, wherein the magnetic unit comprises several permanent magnets surrounding the first electrode and distributed in a circular array and a gap between two adjacent permanent magnets forms a second passage through which the shielding gas passes.

9. A method for magnetic assisted welding, performed using the apparatus of claim 1 for magnetic assisted welding, comprising the following steps:
sleeving the magnetic unit nested with a clamping unit outside the first electrode;
moving the first electrode to abut against a surface of the first to-be-welded workpiece;
introducing shielding gas into an accommodation space of the clamping unit; and
turning on a power supply to enter a weld stage for welding the first to-be-welded workpiece and the second to-be-welded workpiece.

10. The method of claim 9, wherein after turning on the power supply to enter the weld stage for welding the first to-be-welded workpiece and the second to-be-welded workpiece, the method further comprises:
continuously powering to enter a hold stage, and continuously introducing the shielding gas into the accommodation space during the hold stage;
wherein a current intensity of the hold stage is less than or equal to 15% of a current intensity of the weld stage, and an abutment force between the first electrode and the surface of the first to-be-welded workpiece remains unchanged.

11. The apparatus of claim 5, wherein the magnetic unit is a cylindrical permanent magnet surrounding the first electrode, a side wall of the cylindrical permanent magnet is provided with an opening communicating a top surface with a bottom surface and the opening forms a second passage through which the shielding gas passes.

12. The apparatus of claim 6, wherein the magnetic unit is a cylindrical permanent magnet surrounding the first electrode, a side wall of the cylindrical permanent magnet is provided with an opening communicating a top surface with a bottom surface and the opening forms a second passage through which the shielding gas passes.

13. The apparatus of claim 5, wherein the magnetic unit comprises several permanent magnets surrounding the first electrode and distributed in a circular array and a gap between two adjacent permanent magnets forms a second passage through which the shielding gas passes.

14. The apparatus of claim 6, wherein the magnetic unit comprises several permanent magnets surrounding the first electrode and distributed in a circular array and a gap between two adjacent permanent magnets forms a second passage through which the shielding gas passes.
